(19) United States
(12) Patent Application Publication
(10) Pub. No.: US 2010/0206029 A1
(43) Pub. Date: Aug. 19, 2010

(54) Urea formaldehyde polymer additive for odor control of unmanipulated manure

(76) Inventors: Allen R. Sutton, Corydon, KY (US); Martin Case, Bloomington, IL (US); Timothy J. Healey, Saint Louis, MO (US)

Correspondence Address: GREENSFELDER HEMKER & GALE PC, SUITE 2000, 10 SOUTH BROADWAY, ST LOUIS, MO, 63102, US

(21) Appl. No.: 12/658,702

(22) Filed: Feb. 12, 2010

Related U.S. Application Data
(60) Provisional application No. 61/207,709, filed on Feb. 13, 2009.

(51) Int. Cl. C05F 3/00

(52) U.S. Cl. 71/21

(57) ABSTRACT

A method of odor control comprising applying a urea formaldehyde polymer additive to manure in an amount sufficient to reduce or eliminate odor, wherein the polymer optionally contains NBPT and/or DCD, where the polymer can be a dry solid, or it can be suspended in a liquid and applied to unmanipulated liquid or solid manure.

### FIELD OF THE INVENTION

The present invention relates generally to fertilizers. More specifically, the invention relates to unmanipulated manure from confined animal feeding operations (CAFOs) and manure-based fertilizers, and to the use of a urea formaldehyde polymer based additive for manure-based fertilizers that reduces odor.

### BACKGROUND OF THE INVENTION

According to municipalities, government agencies, environmentalists and the public in general, odor and potential pollution sources emanating from livestock, for example, hog, dairy, feedlot and poultry, facilities are the main issues that the livestock industry needs to address in order to sustain its development. The most intense source of odor from livestock facilities occurs during manure handling in barns, feed lots, hog confinement buildings, poultry houses, lagoons, litter/manure piles and during land application.

There are numerous known methods for treating manure including 1) mechanical separation, 2) aerobic treatment; 3) anaerobic treatment; 4) composting; 5) filtration, osmosis and ultrafiltration processes; 6) drying and fertilizers production; 7) biological treatment; and 8) flotation processes. The present invention relates to additives for manure to treat and reduce odor.

U.S. Pat. No. 1,915,240 teaches a sewage purification method which comprises mixing lime and ferric chloride with raw sewage, which deodorizes the waste and causes floc formation. The floc is then oxidized and sterilized before being allowed to settle for subsequent removal and dewatering.

U.S. Pat. Nos. 3,619,420 and 3,640,820 teach a sewage treatment process wherein treated sludge is converted to an active substance by heat treatment and returned to the sewage treatment tank, thereby improving the operational efficiency of the method.

U.S. Pat. No. 4,309,291 teaches a method of continuous flow flocculation and clarification wherein waste water is flocculated by subjecting the mixture to continuous, turbulent flow to and from a settling tank. Clarified effluent and settled flocculent are continuously discharged from the settling tank.

U.S. Pat. No. 4,111,800 teaches a process for treating municipal solid waste and raw sewage sludge wherein municipal waste is mixed with cellulose-containing solid waste.

U.S. Pat. No. 4,180,459 teaches a process of making agricultural products from organic sewage sludge comprising treating sewage sludge with FeCl₃ and CaO from various sources, preferably from sugar refining for flocculation. It is of note that the sewage sludge is characterized as “acidic conditioned sludge” having a pH of between 3.0-5.7.

U.S. Pat. No. 4,209,393 teaches using coal as a sewage sludge additive rather than activated carbon.

U.S. Pat. No. 4,212,732 teaches a raw liquid waste treatment process wherein ash and activated carbon are added to raw sewage to promote settling of flocculent.

U.S. Pat. No. 4,670,158 teaches a method of wastewater treatment wherein lime and phosphoric acid are added to wastewater to promote flocculation. In this method, the pH of the wastewater is adjusted to be within 7.0-10.0, preferably 8.5-9.0 with phosphoric acid.

U.S. Pat. No. 5,698,110 teaches a deodorizing composition for treating animal waste comprising a mixture of lime and cellulose so that the waste can subsequently be used as fertilizer.

U.S. Pat. No. 5,897,785 teaches a process for treating animal waste wherein waste is diluted with water and exposed to radiation to eliminate pathogens. High charge, cationic polymers are then added to the waste such that polymerized solids are formed which are then separated from the waste.

U.S. Pat. No. 5,958,758 teaches a process for treating animal waste wherein sulfide-utilizing bacteria are added to the waste followed by the addition of organic digesting bacteria and lytic enzymes.

U.S. Pat. No. 6,033,570 teaches a process for the treatment of liquid hog manure in which cellulosic material is added to promote removal of solids from the liquid.

U.S. Pat. Nos. 6,039,875 and 6,214,230 teach the use of bacterially-generated polymers as coagulants for the removal of suspended solids from wastewater.

U.S. Pat. Publication 2006/0108291 discloses a method of treating manure with lime and coagulating agents.

### SUMMARY OF THE INVENTION

The present invention is a method of odor control comprising applying a urea formaldehyde polymer additive to manure in an amount sufficient to reduce or eliminate odor. More specifically, the present invention is a method of odor control comprising applying a urea formaldehyde polymer additive to manure, wherein the polymer optionally contains NBPT and/or DCD. The polymer, and the polymer optionally containing NBPT and/or DCD can be a dry solid, or it can be suspended in a liquid and applied to unmanipulated liquid or solid manure.

### DETAILED DESCRIPTION OF THE INVENTION

All percentages are by weight unless otherwise indicated. The additive of the present invention is a urea formaldehyde polymer (UFP) which may be a polymethyl urea resin. The UFP has approximately about 1.0 to 0.01 wt. % reactive methylol groups. The preferred UFP is marketed as PERGOPAK M® 2, a trademark of Albemarle Corporation, which contains from about 10 to 15% water and has about 0.6% reactive methylol groups. It has primary particles of 0.1 to 0.15 micrometers, forming agglomerates of 3.5 to 6.5 micrometers diameter on average. Alternatively, the UFP is the unrefined precursor to PERGOPAK M® 2, sometimes referred to as “the filter cake”, and contains from about 40 to 80 wt. % water. When the UFP is used in an aqueous fertilizer formulation, based on the dry weight of the UFP, the amount of UFP is from about 0.01 to about 12 wt. %, and more preferably in the range of about 0.01 to 1.2 wt. %. If the filter cake is used, greater amounts by weight must be used to achieve the desired results, because of the higher water content of the UFP filter cake.

Optionally, the UFP can be used as a solid urea fertilizer with an aqueous urea formaldehyde (UF) solution or mixture. An example of an aqueous UF solution is UF85, which is a commercially-available solution containing about 25 wt. % urea, about 60 wt. % formaldehyde, and about 15% water, available under the trademark STA-FORM 60®. The aqueous UF solution can be present in the solid urea fertilizer in the range of about 0.01 to 10.0 wt. %. Preferably, the aqueous UF solution or mixture is present in the range of about 0.1 to 1.0 wt. %. When both the UFP and the UF mixture or solution are used, the ratio of the two can range from about 2:1 to 1:100 UFP to UF mixture or solution.

The solid, flowable UFP can be treated with a urease inhibitor, such as N-(n-butyl)thiophosphoric triamide (NBPT), a nitrification inhibitor, such as dicyandiamide (DCD), herbicides, pesticides, micronutrients, etc., before or after combining with the urea source. Alternatively, additional components can be added after the UFP has been combined with the urea source, before granulating the product. Optionally, an aqueous UF solution or mixture may be added to the solid, flowable UFP before granulation.

The additive of the present invention may be a fluid fertilizer composition comprising an aqueous solution of urea or urea ammonium nitrate (UAN), NBPT and DCD. The NBPT is incorporated into the fluid fertilizer composition by preparing a dry flowable additive by coating a dry UFP with a concentrated solution of NBPT in a liquid amide solvent, such as an N-alkyl pyrrolidone. The NBPT is present in the amount of about 0.40 to about 7.0 wt. %. The UFP is present in the range of about 3 to 15 wt. %. Optionally, solid DCD is blended with this dry mixture to further coat the polymer, in the range of about 40 to 85 wt. %. Prior to application, the dry additive is blended with aqueous urea or urea ammonium nitrate (UAN) at the level of from about 0.25 to 1.5 wt. % to form the fluid urea-containing fertilizer composition. The balance of the composition consists primarily of water; an N-alkyl pyrrolidone may also be present in small quantities. The composition may optionally also contain a suspending agent, such as clay, as well as other additives, such as a herbicide, a dye, an NBPT stabilizer, or a micronutrient.

Commercially available products that are suitable as odor control additives are Agrotain® Plus and Agrotain® DC, a trademark of Agrotain International L.L.C. Both products are solids that contain UFP and NBPT, or a combination of UFP, NBPT and DCD. Their compositions are:

Agrotain ® DC:

| | |
|---|---|
| NBPT | 59-61% |
| UFP | 39-40% |
| Dye | 0.1% |

Agrotain ® Plus

| | |
|---|---|
| NBPT | 6.41% |
| DCD | 81.435% |
| UFP | 12.055% |
| Dye | 0.1% |

They can be applied neat, or they can be applied after mixing with water, UAN, other fertilizer components or additional solvents.

### EXAMPLES OF THE INVENTION

The following examples are to illustrate the invention, and are not to limit the scope of the claims in any manner.

In a field test, 240 pounds of Agrotain® Plus (a NBPT, DCD and UFP mixture) were added to 1000 gallons of water. This mixture was added to 810 tons of unmanipulated swine manure. This is an application rate of 0.0147 wt. % for Agrotain® Plus. Breaking down the Agrotain® Plus down into individual components yields an application rate of 0.0009 wt. % for UFP, an application rate of 0.012% of DCD, and an application rate of 0.0009 wt. % NBPT. After application of Agrotain® Plus, a marked reduction of odor was noted.

In the following laboratory-administered test, the additives, below, were mixed with hog manure (wet) at an application rate of 0.009 wt. % for UFP, 0.12 wt. % for DCD, and 0.009 wt. % for NBPT. The resulting mixtures were evaluated for odor control by a blind sniff test. The results of the test are given in Table 1, below.

The application rate is from about 0.1 to about 0.0001 wt. % for the UFP to the manure. Preferably, the application rate is from about 0.01 to about 0.0005 wt. % UFP to manure.

TABLE 1
The Effect of Additives on Odor

| Additive | UFP | NBPT | DCD | Reduced Odor |
|---|---|---|---|---|
| Agrotain ® Plus | Yes | Yes | Yes | Yes |
| Agrotain ® DC | Yes | Yes | No | Yes |
| PERGOPAK M ® | Yes | No | No | Yes |
| UFP | | | | |
| PERGOPAK M ® | Yes | No | No | Yes |
| Filtercake UFP | | | | |
| Control - no | No | No | No | No |
| additive | | | | |

1. A method of odor control comprising applying a urea formaldehyde polymer additive to manure in an amount sufficient to reduce or eliminate odor.

2. The method of claim 1, wherein the application rate is from about 0.1 to about 0.0001 wt. % for the urea formaldehyde polymer to the manure.

3. The method of claim 1, wherein the urea formaldehyde polymer additive contains from 1.0 to 0.1 wt. % methylol groups.

4. The method of claim 1, wherein the urea formaldehyde polymer also contains NBPT.

5. The method of claim 1, wherein the urea formaldehyde polymer also contains DCD.

6. The method of claim 1, wherein the urea formaldehyde polymer is added as a solid.

7. The method of claim 1, wherein the urea formaldehyde polymer is added as an aqueous mixture or solution.

8. The method of claim 1, wherein the urea formaldehyde polymer is added as a mixture with aqueous urea formaldehyde.

9. The method of claim 8, wherein the ratio of dry urea formaldehyde polymer to the aqueous urea formaldehyde is in the range of about 2:1 to 1:100.

10. A method of odor control comprising applying a urea formaldehyde polymer additive to manure in an amount sufficient to reduce or eliminate odor, wherein wherein the application rate is from about 0.1 to about 0.0001 wt. % for the urea formaldehyde polymer to the manure, wherein the urea formaldehyde polymer additive contains from 1.0 to 0.1 wt. % methylol groups.
